(19) United States
(12) Patent Application Publication
(10) Pub. No.: US 2012/0244340 A1
(43) Pub. Date: Sep. 27, 2012

(54) MEMBRANES CONTAINING GROUND VULCANIZED RUBBER

(76) Inventors: Lichih R. Peng, Fishers, IN (US); John Neill, Shelbyville, IN (US); Bruce F. Douglas, Zionsville, IN (US); William B. Gorman, Mooresville, IN (US)

(21) Appl. No.: 13/499,301

(22) PCT Filed: Sep. 30, 2010
(86) PCT No.: PCT/US10/50890

§ 371 Date: Jun. 11, 2012

Related U.S. Application Data
(60) Provisional application No. 61/383,560, filed on Sep. 16, 2010.
(60) Provisional application No. 61/247,187, filed on Sep. 30, 2009.

(51) Int. Cl. B32B 25/02; C08L 21/00; B32B 5/02; C08L 35/00; C08L 31/04

(52) U.S. Cl. 428/327; 525/207; 525/222; 428/454; 428/446; 428/521; 428/451; 428/515; 524/571; 524/517; 524/524; 524/506

(57) ABSTRACT

A multi-layered membrane comprising a first layer that is substantially white in color; and a second layer including ground thermoset rubber.

This application is a national stage application of International Application Serial No. PCT/US2010/050890, filed Sep. 30, 2010, which claims the benefit of U.S. Provisional Application Ser. Nos. 61/247,187, filed on Sep. 30, 2009 and 61/383,560, filed Sep. 16, 2010, which are incorporated herein by reference.

### FIELD OF THE INVENTION

Embodiments of the present invention are directed toward thermoplastic compositions containing ground vulcanized rubber and the use of these compositions in roofing membranes.

### BACKGROUND OF THE INVENTION

Flat or low-sloped roofs are often covered with polymeric membranes. Common among the membranes that have the mechanical properties needed to be technologically useful are thermoset membranes prepared with EPDM rubber, or thermoplastic membranes prepared with ethylene-propylene reactor copolymers or blends of polyethylene and polypropylene. These membranes typically contain carbon black and/or mineral fillers, which provide advantageous mechanical properties to the membranes.

Ground vulcanized rubber has been used as a substitute or supplement to carbon black-filled polymeric systems. The use of ground vulcanized rubber provides a means by which thermoset rubber can be recycled. For example, in the roofing industry, ground thermoset rubber, such as ground tire rubber or ground EPDM roofing membranes, has been recycled by including the ground rubber within walkway pads. While this has proven to be environmentally useful, those skilled in the art appreciate that walkway pads are not subjected to any significant mechanical stresses, and therefore to the extent that the use of the ground thermoset rubber within the walkway pads causes a decrease in mechanical properties, this impact does not impede the usefulness of the walkway pads containing the ground thermoset rubber.

As those skilled in the art understand, however, the use of ground thermoset rubber in certain polymeric compositions and articles can have a deleterious impact on mechanical properties, including low temperature flexability, and this impact can impair the usefulness of the composition or article. This is particularly true in the case of roofing membranes, which must meet certain mechanical tolerances as set forth, for example, in ASTM D6878-03. One solution proposed in the prior art for alleviating the problems associated with the use of ground thermoset rubber includes the use of finely ground thermoset rubber. For example, it has been proposed that the ground thermoset rubber can be reduced to sizes below 100 μm, and that by reducing the ground thermoset rubber to these sizes, deleterious impact, such as loss of mechanical properties, can be alleviated. Unfortunately, this has proven to only be a partial solution and comes at great cost because greater energy and more resources are required to reduce the particle size of the ground thermoset rubber.

In the roofing industry, the decrease in mechanical properties and heat welding capability caused by the use of ground thermoset rubber in membranes has been prohibitive, especially in thermoplastic membranes. In other words, ground thermoset rubber is not used in any commercially-viable thermoplastic roofing membranes because of the loss in mechanical properties and/or costs associated with grinding the thermoset rubber to very small particle sizes.

Because there is a desire to recycle thermoset rubber by using it within thermoplastic membranes, there is a need to overcome issues associated with loss of mechanical properties when ground rubber is employed within the thermoplastic membranes.

### SUMMARY OF THE INVENTION

Embodiments of the present invention provide a multi-layered membrane comprising a first layer that is substantially white in color; and a second layer including ground thermoset rubber.

Other embodiments of the present invention provide a membrane prepared from a polymeric composition comprising a thermoplastic polyolefin; ground thermoset rubber; and a polymeric compatibilizer, where the ground thermoset rubber is dispersed within the thermoplastic polyolefin.

Still other embodiments of the present invention provide thermoplastic composition comprising a thermoplastic polyolefin; ground thermoset rubber; and a polymeric compatibilizer, where the ground thermoset rubber is dispersed within the thermoplastic polyolefin.

### BRIEF DESCRIPTION OF THE DRAWINGS

FIG. 1 is a perspective view of a multi-layered membrane including two co-extruded laminated layers according to embodiments of the present invention.

FIG. 2 is a perspective view of a multi-layered membrane including two laminated layers according to embodiments of the present invention.

FIG. 3 is a perspective view of a laminate membrane according to embodiments of the present invention.

FIG. 4 is a perspective, cross sectional view of a roof assembly according to embodiments of the present invention.

### DETAILED DESCRIPTION OF ILLUSTRATIVE EMBODIMENTS

Embodiments of the present invention are based, at least in part, on the discovery of a thermally-processable composition that includes particles of cured rubber dispersed within a thermoplastic polyolefin matrix. The composition includes a polymeric compatibilizer that advantageously allows for the use of particles of thermoset rubber including thermoset rubber obtained from recycled sources. It has advantageously been discovered that these compositions can be used to fabricate one or more layers of a multi-layered, single-ply membrane, which membranes are useful, among other things, as roofing membranes and geomembranes.

In one or more embodiments, the compositions of the present invention are multi-phase compositions. For example, the particles of thermoset rubber are phase separated from the thermoplastic polyolefin matrix in which it is dispersed. In one or more embodiments, the compatibilizer, which itself may form a dual-phase system having hard domains (e.g., poly(vinyl aromatic) polymer domains) dispersed within a rubber matrix may further add at least one other discrete phase to the overall composition. And, when one or more components or constituents of the system are crosslinked by a peroxide, yet another distinct phase may be present as discrete domains within the matrix. Thus, the compositions of one or more embodiments of the present invention include, at standard temperature and pressure, a thermoplastic polyolefin matrix having dispersed therein discrete domains of particles of thermoset rubber, optionally discrete hard domains deriving from the compatibilizer, and optionally discrete domains of polymer crosslinked by the peroxide.

In one or more embodiments, the domains of the particles of thermoset rubber may be characterized by an average particle size of less than 1,000 μm, in other embodiments less than 800 μm, and in other embodiments less than 600 μm. In these or other embodiments, the discrete domains of the particles of thermoset rubber may be characterized by an average particle size of at least 100 μm, in other embodiments at least 250 μm, and in other embodiments at least 500 μm.

The compositions of the present invention can be prepared by introducing and/or combining a polyolefin, particles of thermoset rubber, a polymeric compatibilizer, optionally an oil, optionally a flame retardant, optionally a peroxide, and optionally other ingredients that may be conventional in the thermoplastic roofing art.

### Ground Thermoset Rubber

Practice of the present invention is not necessarily limited by the composition of the particles of thermoset rubber. In one or more embodiments, the particles of thermoset rubber include an irreversibly set polymer that demonstrates elastomeric properties. In particular embodiments, particles of thermoset rubber include crosslinked olefinic rubber such as EPDM (ethylene-propylene-diene rubber). In other embodiments, the particles of thermoset rubber include crosslinked diene rubber and copolymer rubber. For example, the particles of thermoset rubber include crosslinked polybutadiene or polyisoprene (including natural rubber), butyl rubber, nitrile rubber, or in other embodiments crosslinked styrene-butadiene rubber or crosslinked styrene-isoprene-butadiene rubber.

In one or more embodiments, the particles of thermoset rubber is characterized by a maximum particle size of less than 1,000 μm, in other embodiments less than 900 μm, in other embodiments less than 850 μm, and in other embodiments 750 μm. In these or other embodiments, the ground thermoset rubber is characterized by an number average particle size of from about 100 to 1,000 μm, in other embodiments from about 200 to 900 μm, in other embodiments from about 300 to about 850 μm, and in other embodiments from about 400 to about 750 μm.

In one or more embodiments, the particles of thermoset rubber derive from recycled sources. These recycled sources may include manufacturing scrap, reclaimed materials, rubber waste, and the like, all of which may be referred to as recycled rubber. As is known in the art, the recycled rubber can be ground into desired particle sizes by employing a number of techniques. Practice of the present invention is not necessarily limited by the method by which the particles of rubber are obtained. Accordingly, reference may be made to particles of thermoset rubber or ground thermoset rubber interchangeably. Exemplary methods for grinding thermoset rubber include cryogenic grinding or cracking, mechanical grinding and milling, and the like. In one or more embodiments, the ground thermoset rubber derives from recycled thermoset roofing membrane. In these or other embodiments, the ground thermoset rubber derives from recycled tire rubber.

### Olefinic Thermoplastic Polymers

In one or more embodiments, thermoplastic olefinic polymers include polymers and copolymers including one or more mer units deriving from olefinic monomer. Blends of polymers may also be used. These blends include physical blends as well as reactor blends. In one or more embodiments, the thermoplastic olefinic polymer may derive from recycled thermoplastic polyolefin membranes as described in copending application Ser. No. 11/724,768, which is incorporated herein by reference.

In one or more embodiments, the thermoplastic olefinic polymer may include an olefinic reactor copolymer, which may also be referred to as in-reactor copolymer. Reactor copolymers are generally known in the art and may include blends of olefinic polymers that result from the polymerization of ethylene and α-olefins (e.g., propylene) with sundry catalyst systems. In one or more embodiments, these blends are made by in-reactor sequential polymerization. Reactor copolymers useful in one or more embodiments include those disclosed in U.S. Pat. No. 6,451,897, which is incorporated therein by reference. Reactor copolymers, which are also referred to as TPO resins, are commercially available under the tradename HIFAX™ (Lyondellbassel); these materials are believed to include in-reactor blends of ethylene-propylene rubber and polypropylene or polypropylene copolymers. In one or more embodiments, the in-reactor copolymers may be physically blended with other polyolefins. For example, in reactor copolymers may be blended with linear low density polyethene.

In other embodiments, the thermoplastic olefinic polymer may include a physical blend of chemically-distinct olefinic polymers. In one or more embodiments, blends of propylene-based thermoplastic polymer, plastomer, and/or low density polyethylene may be used. In other embodiments, the thermoplastic olefinic component is a blend of a linear low density polyethylene and a propylene-based plastic.

In one or more embodiments, the propylene-based polymer may include polypropylene homopolymer or copolymers of propylene and a comonomer, where the copolymer includes, on a mole basis, a majority of mer units deriving from propylene. In one or more embodiments, the propylene-based copolymers may include from about 2 to about 6 mole percent, and in other embodiments from about 3 to about 5 mole percent mer units deriving from the comonomer with the remainder including mer units deriving from propylene. In one or more embodiments, the comonomer includes at least one of ethylene and an α-olefin. The α-olefins may include butene-1, pentene-1, hexene-1, oxtene-1, or 4-methyl-pentene-1. In one or more embodiments, the copolymers of propylene and a comonomer may include random copolymers. Random copolymers may include those propylene-based copolymers where the comonomer is randomly distributed across the polymer backbone.

The propylene-based polymers employed in one or more embodiments of this invention may be characterized by a melt flow rate of from about 0.5 to about 15 dg/min, in other embodiments from about 0.7 to about 12 dg/min, in other embodiments from about 1 to about 10 dg/min, and in other embodiments from about 1.5 to about 3 dg/min per ASTM D-1238 at 230° C. and 2.16 kg load. In these or other embodiments, the propylene-based polymers may have a weight average molecular weight (M_{w}) of from about 1×10⁵ to about 5×10⁵ g/mole, in other embodiments from about 2×10⁵ to about 4×10⁵ g/mole, and in other embodiments from about 3×10⁵ to about 4×10⁵ g/mole, as measured by GPC with polystyrene standards. The molecular weight distribution of these propylene-based copolymer may be from about 2.5 to about 4, in other embodiments from about 2.7 to about 3.5, and in other embodiments from about 2.8 to about 3.2.

In one or more embodiments, propylene-based polymers may be characterized by a melt temperature (Tₘ) that is from about 165° C. to about 130° C., in other embodiments from about 160 to about 140° C., and in other embodiments from about 155° C. to about 140° C. In one or more embodiments, particularly where the propylene-based polymer is a copolymer of propylene and a comonomer, the melt temperature may be below 160° C., in other embodiments below 155° C., in other embodiments below 150° C., and in other embodiments below 145° C. In one or more embodiments, they may have a crystallization temperature (T_{c}) of about at least 90° C., in other embodiments at least about 95° C., and in other embodiments at least 100° C., with one embodiment ranging from 105° to 115° C.

Also, these propylene-based polymers may be characterized by having a heat of fusion of at least 25 J/g, in other embodiments in excess of 50 J/g, in other embodiments in excess of 100 J/g, and in other embodiments in excess of 140 J/g.

In one or more embodiments, the propylene-based polymers may be characterized by a flexural modulus, which may also be referred to as a 1% secant modulus, in excess of 120,000 psi, in other embodiments in excess of 125,000, in other embodiments in excess of 130,000 psi, in other embodiments in excess of 133,000 psi, in other embodiments in excess of 135,000 psi, and in other embodiments in excess of 137,000 psi, as measured according to ASTM D-790.

Useful propylene-based polymers include those that are commercially available. For example, propylene-based polymers can be obtained under the tradename PP7620Z™ (Fina), PP33BF01™ (Equistar), or under the tradename TR3020™ (Sunoco).

In one or more embodiments, the thermoplastic polymer may include a blend of olefinic polymers. Useful blends include those described in International Application No. PCT/US06/033522 which is incorporated herein by reference. For example, a particular blend may include (i) a plastomer, (ii) a low density polyethylene, and (iii) a propylene-based polymer.

In one or more embodiments, the plastomer includes an ethylene-α-olefin copolymer. The plastomer employed in one or more embodiments of this invention includes those described in U.S. Pat. Nos. 6,207,754, 6,506,842, 5,226,392, and 5,747,592, which are incorporated herein by reference. This copolymer may include from about 1.0 to about 15 mole percent, in other embodiments from about 2 to about 12, in other embodiments from about 3 to about 9 mole percent, and in other embodiments from about 3.5 to about 8 mole percent mer units deriving from α-olefins, with the balance including mer units deriving from ethylene. The α-olefin employed in preparing the plastomer of one or more embodiments of this invention may include butene-1, pentene-1, hexene-1, octene-1, or 4-methyl-pentene-1.

The plastomer of one or more embodiments of this invention can be characterized by a density of from about 0.865 g/cc to about 0.900 g/cc, in other embodiments from about 0.870 to about 0.890 g/cc, and in other embodiments from about 0.875 to about 0.880 g/cc per ASTM D-792. In these or other embodiments, the density of the plastomers may be less than 0.900 g/cc, in other embodiments less than 0.890 g/cc, in other embodiments less than 0.880 g/cc, and in other embodiments less than 0.875 g/cc.

In one or more embodiments, the plastomer may be characterized by a weight average molecular weight of from about 7×10⁴ to 13×10⁴ g/mole, in other embodiments from about 8×10⁴ to about 12×10⁴ g/mole, and in other embodiments from about 9×10⁴ to about 11×10⁴ g/mole as measured by using GPC with polystyrene standards. In these or other embodiments, the plastomer may be characterized by a weight average molecular weight in excess of 5×10⁴ g/mole, in other embodiments in excess of 6×10⁴ g/mole, in other embodiments in excess of 7×10⁴ g/mole, and in other embodiments in excess of 9×10⁴ g/mole. In these or other embodiments, the plastomer may be characterized by a molecular weight distribution (M_{w}/Mₙ) that is from about 1.5 to 2.8, in other embodiments 1.7 to 2.4, and in other embodiments 2 to 2.3.

In these or other embodiments, the plastomer may be characterized by a melt index of from about 0.1 to about 8, in other embodiments from about 0.3 to about 7, and in other embodiments from about 0.5 to about 5 per ASTM D-1238 at 190° C. and 2.16 kg load.

The uniformity of the comonomer distribution of the plastomer of one or more embodiments, when expressed as a comonomer distribution breadth index value (CDBI), provides for a CDBI of greater than 60, in other embodiments greater than 80, and in other embodiments greater than 90.

In one or more embodiments, the plastomer may be characterized by a DSC melting point curve that exhibits the occurrence of a single melting point break occurring in the region of 50 to 110° C.

The plastomer of one or more embodiments of this invention may be prepared by using a single-site coordination catalyst including metallocene catalyst, which are conventionally known in the art.

Useful plastomers include those that are commercially available. For example, plastomer can be obtained under the tradename EXXACT™ 8201 (ExxonMobil); or under the tradename ENGAGE™ 8180 (Dow DuPont).

In one or more embodiments, the low density polyethylene includes an ethylene-α-olefin copolymer. In one or more embodiments, the low density polyethylene includes linear low density polyethylene. The linear low density polyethylene employed in one or more embodiments of this invention may be similar to that described in U.S. Pat. No. 5,266,392, which is incorporated herein by reference. This copolymer may include from about 2.5 to about 13 mole percent, and in other embodiments from about 3.5 to about 10 mole percent, mer units deriving from α-olefins, with the balance including mer units deriving from ethylene. The α-olefin included in the linear low density polyethylene of one or more embodiments of this invention may include butene-1, pentene-1, hexene-1, octene-1, or 4-methyl-pentene-1. In one or more embodiments, the linear low density polyethylene is devoid or substantially devoid of propylene mer units (i.e., units deriving from propylene). Substantially devoid refers to that amount or less of propylene mer units that would otherwise have an appreciable impact on the copolymer or the compositions of this invention if present.

The linear low density polyethylene of one or more embodiments of this invention can be characterized by a density of from about 0.885 g/cc to about 0.930 g/cc, in other embodiments from about 0.900 g/cc to about 0.920 g/cc, and in other embodiments from about 0.900 g/cc to about 0.910 g/cc per ASTM D-792.

In one or more embodiments, the linear low density polyethylene may be characterized by a weight average molecular weight of from about 1×10⁵ to about 5×10⁵ g/mole, in other embodiments 2×10⁵ to about 10×10⁵ g/mole, in other embodiments from about 5×10⁵ to about 8×10⁵ g/mole, and in other embodiments from about 6×10⁵ to about 7×10⁵ g/mole as measured by GPC with polystyrene standards. In these or other embodiments, the linear low density polyethylene may be characterized by a molecular weight distribution (M_{w}/Mₙ) of from about 2.5 to about 25, in other embodiments from about 3 to about 20, and in other embodiments from about 3.5 to about 10. In these or other embodiments, the linear low density polyethylene may be characterized by a melt flow rate of from about 0.2 to about 10 dg/min, in other embodiments from about 0.4 to about 5 dg/min, and in other embodiments from about 0.6 to about 2 dg/min per ASTM D-1238 at 230° C. and 2.16 kg load.

The linear low density polyethylene of one or more embodiments of this invention may be prepared by using a convention Ziegler Natta coordination catalyst system.

Useful linear low density polyethylene includes those that are commercially available. For example, linear low density polyethylene can be obtained under the tradename Dowlex™ 2267G (Dow); or under the tradename DFDA-1010 NT7 (Dow); or under the tradename GA502023 (Lyondell).

### Compatibilizer

In one or more embodiments, the compatibilizer employed in the present invention is a polymeric compatibilizer that includes an amorphous component and a polar functionality; e.g., a substituent having an electrical charge. As those skilled in the art understand, this electrical charge can derive from the presence or absence of one or more electrons such as the case with a Lewis acid or Lewis base. Without wishing to be bound by any particular theory, it is believed that the polar functionality reacts or interacts with the surface of the ground thermoset rubber.

In one or more embodiments, the polar functionality is a substituent that is a proton donor; i.e., an bronsted acid. As those skilled in the art appreciate, acid functionalities include those functionalities that may be considered proton donors. In other embodiments, acid functionalities include those functionalities that may be considered electron acceptors.

Examples of polar groups include carboxyl, hydroxyl, alkoxyl, ether, ester, amino, imino, and anhydride groups. The acid or anhydride groups may derive from unsaturated carboxylic acids or unsaturated anhydrides. Examples of unsaturated carboxylic acids include citraconic acid, cinnamic acid, methacrylic acid, and itaconic acid. Examples of unsaturated anhydrides include maleic anhydride, citraconic anhydride, and itaconic anhydride. In one embodiment, the functional group includes a succinic anhydride group, or the corresponding acid, which may derive from a reaction (e.g., polymerization or grafting reaction) with maleic anhydride, or a β-alkyl substituted propanoic acid group or derivative thereof. In one or more embodiments, the functional group is pendant to the backbone of the polymeric compatibilizer.

Without wishing to be bound by any particular theory, it is believed that the amorphous component is compatible and/or miscible with amorphous regions within the plastic region (e.g., the ethylene-propylene rubber or the linear low density polyethylene). As those skilled in the art appreciate, an amorphous component or region of a polymer is a region or component that has little or no crystallinity. In one or more embodiments, the crystallinity of the region or component is less than 10 percent, in other embodiments less than 5 percent, and in other embodiments less than 1 percent, based on the weight of the continuous thermoplastic phase or matrix.

The amorphous region or segment of the polymeric compatibilizer may include an amorphous block, such as may be the case with a block copolymer including hard and soft segments. In other embodiments, the amorphous component may derive from disruption in an olefinic chain such as ethylene or propylene chains. For example, the crystallinity of polyethylene can be disrupted by copolymerization with an acrylate monomer to produce a polymer backbone or segments therein that are amorphous.

In one or more embodiments, the polymeric compatibilizer including an amorphous component and an acidic functionality may be a functionalized block copolymer. In one or more embodiments, useful functionalized block copolymers include block copolymers including at least one hard block or segment, at least one soft block or segment, and at least one functional group. In certain embodiments, the block copolymer include two hard blocks with a soft block positioned therebetween (i.e., ABA bock copolymer). In other embodiments, the block copolymer includes two soft blocks with a hard block positioned therebetween (i.e., BAB block copolymer). The functional group or groups may be within or pendant to the hard segments, the soft segments, or both the hard and soft segments.

In one or more embodiments, the soft blocks can be characterized by a glass transition temperature (Tg) of less than 25° C., in other embodiments less than 0° C., and in other embodiments less than −20° C.

In one or more embodiments, the soft block can include a unit or units deriving from conjugated diene monomers and optionally vinyl aromatic monomers. Suitable diene monomers include 1,3-butadiene, isoprene, piperylene, phenylbutadiene, and mixtures thereof. Those units deriving from conjugated diene monomers can optionally be hydrogenated. Suitable vinyl aromatic monomers include styrene, alkyl-substituted styrenes such as paramethyl styrene, and α-methyl styrene, as well as mixtures thereof.

In one or more embodiments, the hard blocks can be characterized by a glass transition temperature (Tg) of greater than 25° C., in other embodiments greater than 50° C., and in other embodiments greater than 75° C.

In one or more embodiments, the hard blocks can include polymeric units deriving from vinyl aromatic monomers. Useful vinyl aromatics include styrene, alkyl-substituted styrenes such as paramethyl styrene, and α-methyl styrene, as well as mixtures thereof.

In one or more embodiments, examples of useful block copolymers that can be functionalized include, but are not limited to, styrene/butadiene rubber (SBR), styrene/isoprene rubber (SIR), styrene/isoprene/butadiene rubber (SIBR), styrene-butadiene-styrene block copolymer (SBS), hydrogenated styrene-butadiene-styrene block copolymer (SEBS), hydrogenated styrene-butadiene block copolymer (SEB), styrene-isoprene-styrene block copolymer (SIS), styrene-isoprene block copolymer (SI), hydrogenated styrene-isoprene block copolymer (SEP), hydrogenated styrene-isoprene-styrene block copolymer (SEPS), styrene-ethylene/butylene-ethylene block copolymer (SEBE), styrene-ethylene-styrene block copolymer (SES), ethylene-ethylene/butylene block copolymer (EEB), ethylene-ethylene/butylene/styrene block copolymer (hydrogenated BR-SBR block copolymer), styrene-ethylene/butylene-ethylene block copolymer (SEBE), ethylene-ethylene/butylene-ethylene block copolymer (EEBE) and mixtures thereof. Preferred copolymers include hydrogenated styrene-butadiene-styrene block copolymer (SEBS), and hydrogenated styrene-isoprene-styrene block copolymer (SEPS).

In one or more embodiments, the block copolymers include those disclosed in U.S. Pat. Nos. 6,177,517 B1, and 6,369,160 B1, which are incorporated herein by reference, as well as International Patent Applications WO 96/20249 and WO 96/23823, which is incorporated herein by reference.

Other thermoplastic elastomer block copolymers include block copolymers of a hydrogenated styrene block copolymer (e.g., SEPS or SEBS) and thermoplastic polyurethane. These copolymers are commercially available under the tradename S 5865 (Septon).

In one or more embodiments, the degree of functionalization of the functionalized block copolymer may be recited in terms of the weight percent of the pendent functional moiety based on the total weight of the functionalized block copolymer. In one or more embodiments, the functionalized block copolymer may include at least 0.2% by weight, in other embodiments at least 0.4% by weight, in other embodiments at least 0.6% by weight, and in other embodiments at least 1.0 weight percent functionalization. In these or other embodiments, the functionalized block copolymers may include less than 5% by weight, in other embodiments less than 3% by weight, and in other embodiments less than 2% by weight functionalization. In these or other embodiments, functionalized block copolymers may include from about 1.0 to about 7, in other embodiments from about 2 to about 6, and in other embodiments form about 3 to about 5 weight % mer units that include a functional group.

In one or more embodiments, functionalized block copolymers may be prepared by copolymerizing functional monomers with non-functional monomer. In other embodiments, the functionalized block copolymer may be prepared by grafting a graft monomer to a polymer. The process of grafting may include combining, contacting, or reacting a polymer with a graft monomer. These functionalized block copolymers include those described in U.S. Pat. Nos. 4,957,968, 5624,999, 6,503,984, 6,653,408 and 5,506,299.

In one or more embodiments, the functionalized block copolymer is a functionalized, hydrogenated block copolymer. Suitable block copolymers as a precursor to the functionalized, hydrogenated block copolymers may have varying structures containing various ratios of conjugated dienes to vinyl aromatic hydrocarbons including those containing up to about 60 percent by weight of vinyl aromatic hydrocarbon. Thus, multiblock copolymers may be utilized which are linear or radial, symmetric or asymmetric, and which have structures represented by the formulae, A-B, A-B-A, A-B-A-B, B-A-B, (AB)_{0, 1, 2, . . .} -BA and the like wherein A is a polymer block of a vinyl aromatic hydrocarbon or a conjugated diene/vinyl aromatic hydrocarbon tapered copolymer block comprising at least 80 wt % of the vinyl/aromatic hydrocarbon and B is a polymer block of a conjugated or a conjugated diene/vinyl/aromatic tapered copolymer block comprising at least 80 wt % of the conjugated diene. Suitably, the A block or blocks compose 5 to 60, 5 to 30, percent by weight of the copolymer. These blocks suitably have a number average molecular weight of 2,000 to 115,000 to, for example, 4,000 to 60,000. Suitably, the B block or blocks have a number average molecular weight of 20,000 to 450,000. In particular embodiments, the block copolymer is a tri-block having the A-B-A structure, or in other embodiments an ABA block copolymer having polystyrene end blocks.

The block copolymers may be produced by any well known block polymerization or copolymerization procedures including the well known sequential addition of monomer techniques, incremental addition of monomer technique or coupling technique as illustrated in, for example, U.S. Pat. Nos. 3,251,905; 3,390,207; 3,598,887 and 4,219,627, which are incorporated herein by reference.

The acid functionalized block copolymer may be prepared by graft-reacting an acid moiety or its derivative onto the hydrogenated block copolymer via a free radically initiated reaction. Suitable monomers that may be grafted include unsaturated mono- and polycarboxylic acids and anhydrides containing from about 3 to about 10 carbons. Examples of monomers are fumaric acid, itaconic acid, citraconic acid, acrylic acid, maleic anhdride, itaconic anhydride, and citraconic anhydride. The preferred grafting monomer is maleic anhydride. The grafted polymer may contain from 0.1 to 10, or in other embodiments 0.2 to 5 percent by weight of grafted monomer.

The grafting reaction can be carried out in solution or by melt-mixing the base block copolymer and the acid/anhydride monomer in the presence of a free radical initiator. Examples of processes are found in U.S. Pat. Nos. 4,033,888; 4,077,893; and 4,670,173 for solution processes and in U.S. Pat. Nos. 4,427,828; 4,578,429; 4,628,072; and 4,657,971 for melt-mixing processes, all of which are incorporated herein by reference.

Suitable functionalized block copolymers are commercially available from any of the KRATON Polymer companies. Examples are KRATON® G1652, KRATON® G1657, KRATON® G1726, KRATON® FG1901 and KRATON® FG1924.

In other embodiments, the compatibilizer may include a random terpolymer of ethylene, acrylic ester; e.g., butyl acrylate, and maleic anhydride. Useful acrylic esters include methyl acrylate, ethyl acrylate, propyl acrylate, and butyl acrylate. The acrylic ester may be present in an amount from about 10 to about 25%, in other embodiments from about 12 to about 20%, and in other embodiments from about 16 to about 18%, based on weight percent. The maleic anhydride may be present in an amount from about 1 to about 5%, and in other embodiments from about 2 to about 4%, based on a weight percent. These copolymers are available under the tradename Lotader 3410 and 3430 (ARKEMA).

In other embodiments, the compatibilizer may include polyethylene vinyl acetate (EVA). As those skilled in the art appreciate, polyethylene vinyl acetate is a copolymer of ethylene and vinyl acetate. In general, the weight percent vinyl acetate may vary from about 10 to about 40 weight percent, with the remainder being ethylene. In one or more embodiments, the EVA is characterized by a melt index (ASTM D-1238 @ 190° C. with 2160 gram load) of from about 1 dg/min to about 10 dg/min, in other embodiments from about 1.5 dg/min to about 7 dg/min, and in other embodiments from about 2 dg/min to about 5 dg/min.

### Oil

In one or more embodiments, the compositions of this invention may include a mineral oil, a synthetic oil, or a combination thereof. These oils may also be referred to as plasticizers or extenders. Mineral oils may include aromatic, naphthenic, paraffinic, and isoparaffinic oils. In one or more embodiments, the mineral oils may be treated or untreated. Useful mineral oils can be obtained under the tradename SUNPAR™ (Sun Chemicals). Others are available under the name PARALUX™ (Chevron).

In one or more embodiments, synthetic oils include polymers and oligomers of butenes including isobutene, 1-butene, 2-butene, butadiene, and mixtures thereof. In one or more embodiments, these oligomers can be characterized by a number average molecular weight (Mₙ) of from about 300 g/mole to about 9,000 g/mole, and in other embodiments from about 700 g/mole to about 1,300 g/mole. In one or more embodiments, these oligomers include isobutenyl mer units. Exemplary synthetic oils include polyisobutylene, poly(isobutylene-co-butene), and mixtures thereof. In one or more embodiments, synthetic oils may include polylinear α-olefins, poly-branched α-olefins, hydrogenated polyalphaolefins, and mixtures thereof.

In one or more embodiments, the synthetic oils include synthetic polymers or copolymers having a viscosity in excess of about 20 cp, in other embodiments in excess of about 100 cp, and in other embodiments in excess of about 190 cp, where the viscosity is measured by a Brookfield viscometer according to ASTM D-4402 at 38° C. In these or other embodiments, the viscosity of these oils can be less than 4,000 cp and in other embodiments less than 1,000 cp.

Useful synthetic oils can be commercially obtained under the tradenames Polybutene™ (Soltex; Houston, Tex.), and Indopol™ (Innouvene). White synthetic oil is available under the tradename SPECTRASYN™ (ExxonMobil), formerly SHF Fluids (Mobil) and Elevast™ (ExxonMobil). Oils described in U.S. Pat. No. 5,936,028 may also be employed. It is believed that synthetic oils may provide enhanced low temperature performance. Also, high temperature performance may be enhanced based upon molecular structure.

### Flame Retardant

In one or more embodiments, flame retardants may include any compound that will increase the burn resistivity, particularly flame spread such as tested by UL 94 and/or UL 790, of the laminates of the present invention. Useful flame retardants include those that operate by forming a char-layer across the surface of a specimen when exposed to a flame. Other flame retardants include those that operate by releasing water upon thermal decomposition of the flame retardant compound. Useful flame retardants may also be categorized as halogenated flame retardants or non-halogenated flame retardants.

Exemplary non-halogenated flame retardants include magnesium hydroxide, aluminum trihydrate, zinc borate, ammonium polyphosphate, melamine polyphosphate, and antimony oxide (Sb₂O₃). Magnesium hydroxide (Mg(OH)₂) is commercially available under the tradename Vertex™ 60, ammonium polyphosphate is commercially available under the tradename Exolite™ AP 760 (Clarian), which is sold together as a polyol masterbatch, melamine polyphosphate is available under the tradename Budit™ 3141 (Budenheim), and antimony oxide (Sb₂O₃) is commercially available under the tradename Fireshield™. Those flame retardants from the foregoing list that are believed to operate by forming a char layer include ammonium polyphosphate and melamine polyphosphate.

In one or more embodiments, treated or functionalized magnesium hydroxide may be employed. For example, magnesium oxide treated with or reacted with a carboxylic acid or anhydride may be employed. In one embodiment, the magnesium hydroxide may be treated or reacted with stearic acid. In other embodiments, the magnesium hydroxide may be treated with or reacted with certain silicon-containing compounds. The silicon-containing compounds may include silanes, polysiloxanes including silane reactive groups. In other embodiments, the magnesium hydroxide may be treated with maleic anhydride. Treated magnesium hydroxide is commercially available. For example, Zerogen™ 50.

Examples of halogenated flame retardants may include halogenated organic species or hydrocarbons such as hexabromocyclododecane or N,N′-ethylene-bis-(tetrabromophthalimide). Hexabromocyclododecane is commercially available under the tradename CD-75P™ (ChemTura). N,N′-ethylene-bis-(tetrabromophthalimide) is commercially available under the tradename Saytex™ BT-93 (Albemarle).

In one or more embodiments, the use of char-forming flame retardants (e.g. ammonium polyphosphate and melamine polyphosphate) has unexpectedly shown advantageous results when used in conjunction with nanoclay within the cap layer of the laminates of the present invention. It is believed that there may be a synergistic effect when these compounds are present in the cap layer. As a result, the cap layer of the laminates of the certain embodiments of the present invention are devoid of or substantially devoid of halogenated flame retardants and/or flame retardants that release water upon thermal decomposition. Substantially devoid referring to that amount or less that does not have an appreciable impact on the laminates, the cap layer, and/or the burn resistivity of the laminates.

### Other Ingredients

In one or more embodiments, the compositions of this invention may include a processing aid. Processing aids include those compounds that can be added to the thermoplastic polymer composition to assist in processing or extend the polymeric materials. In one or more embodiments, processing aids include those compounds that can reduce the viscosity and/or increase the flow of the thermoplastic polymer. Exemplary processing aids include metal salts of carboxylic acids including metal salts of naturally occurring fats and oils. In one or more embodiments, processing aids include calcium stearate and/or zinc stearate. In other embodiments, processing aids include processing oils such as those that are conventional in plastics and/or rubber processing.

In one or more embodiments, the compositions of the invention may include a stabilizers. Stabilizers may include one or more of a UV stabilizer, an antioxidant, and an antiozonant. UV stabilizers include Tinuvin™ 622. Antioxidants include Irganox™ 1010. In one or more embodiments, carbon black is used as a stabilizer. Advantageously, the carbon black may be used for this purpose at levels of less than 5 wt. %, in other embodiments less than 3 wt. %, and in other embodiments less than 2 wt. %, based on the entire weight of the composition.

In addition to the foregoing, one or more layers may also include other ingredients or constituents that are commonly included in polymeric compounds. In certain embodiments, especially where the membrane is employed as a geomembrane, carbon black may be employed as a pigment or reinforcement.

### Peroxide

Free-radical cure agents include peroxides such as organic peroxides. Examples of organic peroxides include, but are not limited to, di-tert-butyl peroxide, dicumyl peroxide, t-butylcumyl peroxide, α,α-bis(tert-butylperoxfy) diisopropyl benzene, 2,5-dimethyl-2,5-di(t-butylperoxy) hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Others include azo initiators including Luazo™ AP (ARCHEMA). Useful peroxides and their methods of use in dynamic vulcanization of thermoplastic vulcanizates are disclosed in U.S. Pat. No. 5,656,693, which is incorporated herein by reference for purpose of U.S. patent practice. In certain embodiments, cure systems such as those described in U.S. Pat. No. 6,747,099, U.S. Application Publication No. 20040195550, and WIPO Publication Nos. 2002/28946, 2002/077089, and 2005/092966, may also be employed.

In one or more embodiments, the free-radical cure agent may be employed in conjunction with one or more coagents. Coagents may include high-vinyl polydiene or polydiene copolymer, triallylcyanurate, triallyl isocyanurate, triallyl phosphate, sulfur, N,N′-m-phenylenedimaleimide, N,N′-p-phenylenedimaleimide, divinyl benzene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, multi-functional acrylates, multi-functional methacrylates, or oximers such as quinone dioxime. Combinations of these coagents may be employed.

### Amounts

In one or more embodiments, the composition of the present invention may include greater than 50, in other embodiments greater than 60, and in other embodiments greater than 70 percent by weight ground thermoset rubber based on the total weight of the composition. In these or other embodiments, the composition of the present invention may include less than 95, in other embodiments less than 85, and in other embodiments less than 75 percent by weight ground thermoset rubber based on the total weight of the composition.

In one or more embodiments, the composition of the present invention may include greater than 3, in other embodiments greater than 5, and in other embodiments greater than 10 percent by weight olefinic thermoplastic based on the total weight of the composition. In these or other embodiments, the composition of the present invention may include less than 25, in other embodiments less than 20, and in other embodiments less than 15 percent by weight olefinic thermoplastic based on the total weight of the composition.

In those embodiments where the olefinic thermoplastic component includes a blend of propylene-based plastic and linear low density polyethylene, the weight ratio of propylene-based plastic to linear low density polyethylene may be from about 1:1 to about 1:5, in other embodiments from about 1:1.5 to about 1:4, and in other embodiments from about 1:2 to about 1:3.5.

In one or more embodiments, the composition of the present invention may include greater than 5, in other embodiments greater than 7.5, and in other embodiments greater than 10 percent by weight compatibilizer (e.g., functionalized block copolymer) based on the total weight of the composition. In these or other embodiments, the composition of the present invention may include less than 15, in other embodiments less than 13, and in other embodiments less than 11 percent by weight compatibilizer based on the total weight of the composition.

In one or more embodiments, the composition of the present invention may include greater than 2, in other embodiments greater than 3, in other embodiments greater than 5, in other embodiments greater than 7.5, and in other embodiments greater than 10 percent by weight oil based on the total weight of the composition. In these or other embodiments, the composition of the present invention may include less than 20, in other embodiments less than 18, and in other embodiments less than 15 percent by weight oil based on the total weight of the composition.

Those skilled in the art will be able to readily select an appropriate amount of the other ingredients that may be used in the compositions of this invention. For example, the other ingredients such as the processing additives, UV stabilizers, and antioxidants may be used, although the amounts may vary, in amounts from about 0.1 to about 2 percent, in other embodiments from about 0.5 to about 1.5 percent, and in other embodiments from about 0.7 to about 1.3 percent, based on the total weight of the composition. In particular embodiments, the compositions including ground thermoset rubber include less than 10 weight percent, in other embodiments less than 8 weight percent, in other embodiments less than 5 weight percent, and in other embodiments less than 3 weight percent filler or flame retardant based on the entire weight of the thermoplastic polyolefin, ground rubber, and compatibilizer.

The skilled artisan will be able to readily determine a sufficient or effective amount of curative and/or coagent to be employed without undue calculation or experimentation. Those skilled in the art appreciate that the amount of curative employed may vary based upon the chemical nature of the peroxide and/or coagent employed.

### Method of Making

In one or more embodiments, the compositions and membranes of the present invention may be prepared by employing conventional techniques. For example, the various ingredients can be separately fed into a reaction extruder and pelletized or directly extruded into membrane or laminate sheet. In other embodiments, the various ingredients can be combined and mixed within a mixing apparatus such as an internal mixer and then subsequently fabricated into membrane sheets or laminates.

In one or more embodiments, the membranes of the present invention may be prepared by extruding a polymeric composition into a sheet. Multiple sheets may be extruded and joined to form a laminate. A membrane including a reinforcing layer may be prepared by extruding at least one sheet on and/or below a reinforcement (e.g., a scrim). In other embodiments, the polymeric layer may be prepared as separate sheets, and the sheets may then be calandered with the scrim sandwiched therebetween to form a laminate. In one or more embodiments, the membranes of the present invention are prepared by employing co-extrusion technology. Useful techniques include those described in co-pending U.S. Ser. Nos. 11/708,898 and 11/708,903, which are incorporated herein by reference.

Following extrusion, and after optionally joining one or more polymeric layers, or optionally joining one or more polymeric layer together with a reinforcement, the membrane may be fabricated to a desired thickness. This may be accomplished by passing the membrane through a set of squeeze rolls positioned at a desired thickness. The membrane may then be allowed to cool and/or rolled for shipment and/or storage.

The polymeric composition that may be extruded to form the polymeric sheet may include the ingredients or constituents described herein. For example, the polymeric composition may include thermoplastic polyolefin, compatibilizer, and ground thermoset rubber. The ingredients may be mixed together by employing conventional polymer mixing equipment and techniques. In one or more embodiments, an extruder may be employed to mix the ingredients. For example, single-screw or twin-screw extruders may be employed.

In one embodiment, each of the polymeric ingredients (e.g., compatibilizer, low density polyethylene, and propylene copolymer) may be added to the extruder at the feed throat of the extruder. The filler and other ingredients (e.g., ground thermoset rubber) that may be desirable may be added at the feed throat or within a subsequent stage or barrel of the extruder (e.g., downstream of the feed throat). This can be accomplished, for example, by using a side feeder. One or more of the polymeric ingredients may also be added downstream of the feed throat. This may include partial addition at the feed throat and partial addition downstream, or complete downstream addition of one or more polymeric ingredients. The optional peroxide can be added at various locations within the extruder. For example, the peroxide can be pre-blended with the oil and added downstream of the rubber addition.

In one or more embodiments, the process for making the composition of the present invention includes introducing the polyolefin, and the functionalized block copolymer, as well as optional ingredients such as stabilizer and processing aids, to a reaction extruder at the feed throat. This mixture is then kneaded under high shear and at temperatures above the melting point of the polyolefin (temperatures in excess of 200° C., in other embodiments in excess of 220° C., and in other embodiments in excess of 230° C.), to obtain a free-flowing melted composition. Once this is achieved, the composition can be conveyed downstream within the extruder under low shear such as may be achieved by using conveying elements in the absence or substantial absence of kneading elements. At this point in time, the ground thermoset rubber can be introduced into the extruder. Immediately following the introduction of the ground thermoset rubber, oil can be introduced into the extruder downstream of the introduction of the ground thermoset rubber. This also can occur under low shear conditions such as may be achieved by the use of conveying elements in the absence or substantial absence of kneading elements. In addition to the oil, the optional peroxide can be added together with the oil. For example, a pre-blend of peroxide and oil can be injected into the reaction extruder immediately following the introduction of the ground thermoset rubber. After addition of the oil and optional peroxide, the composition may undergo a series of mixing and conveying operations within the extruder under temperatures in excess of the melting temperature of the thermoplastic resin (e.g., in excess of 200° C.), and a vacuum can be pulled on one or more zones of the extruder in order to remove volatiles.

### Multi-Layered Membrane

In one or more embodiments, the compositions of the present invention can be used to prepare one or more layers of a multi-layered membrane (which membranes may also be referred to as laminates). In particular embodiments, the compositions of the present invention (i.e, those including ground thermoset rubber) are employed to prepare the inner layer or layers of a multi-layered membrane. In these or other embodiments, the composition of this invention can be used to form the lower layers of the laminate. In particular embodiments, the top layer, which is the layer exposed to the environment when the roofing membrane is installed on a roof, is white or substantially white in color. This particular combination produces a membrane that is highly advantageous in several respects. First, the membrane recycles ground thermoset rubber. Second, the membrane is itself recyclable, due to the fact that it is a thermoplastic membrane. Third, by having a white exterior surface, the membrane can reflect infrared radiation and thereby reduce energy demands that may be required to keep any building cool that the membrane is covering. Moreover, the white exterior surface can reflect electromagnetic radiation (e.g., ultraviolet radiation) that can have a deleterious impact on the inner layer or lower layers that include the ground thermoset rubber.

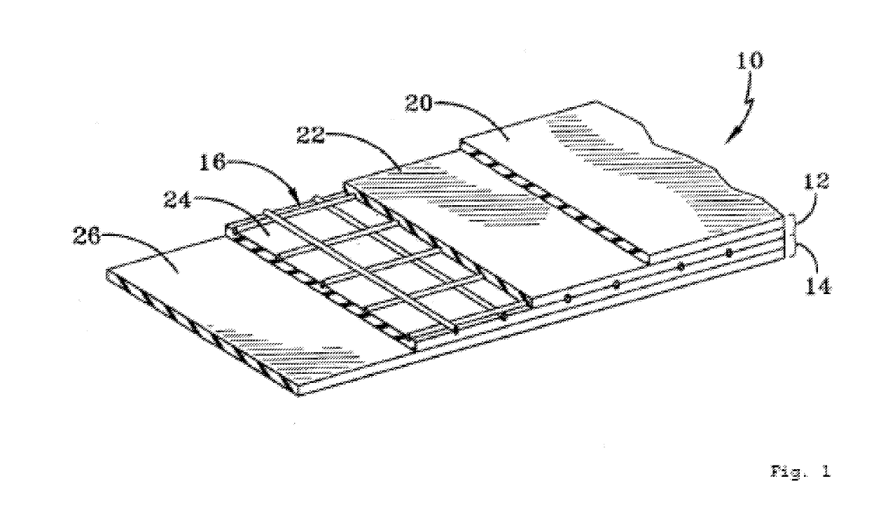

A particular embodiment of the present invention is shown in FIG. 1. Membrane 10 includes 4 layers that may be prepared by coextruding two or more layers together. In particular embodiments, two layers are coextruded and subsequently laminated to another laminate including two coextruded layers. In optional embodiments, a scrim or other reinforcement may be placed between the coextruded laminates. As specifically shown in FIG. 1, top layer 20 may be coextruded with upper-inner layer 22. And bottom layer 26 may be coextruded with lower-inner layer 24. The sub assemblies may then be laminated to one another after optional scrim 16 is placed therebetween. In other words, sub assembly 12 is laminated to sub assembly 14.

In particular embodiments, top layer 20, which may be the layer of the laminate that is exposed to the environment when installed on a roof, is white or substantially white. In these or other embodiments, top layer 20 is devoid or substantially devoid of ground thermoset rubber, while upper inner-layer 22 includes ground thermoset rubber dispersed in a thermoplastic polyolefin according to the present invention. Besides the absence of the ground thermoset rubber, top layer 20 may include thermoplastic polyolefin that is similar to or the same as the thermoplastic polyolefin forming the matrix of the layers including the ground thermoset rubber. Additionally, top layer 20 may include other constituents that are conventionally employed in thermoplastic roofing membranes. As is known in the art, these constituents may include antioxidants, UV stabilizers, flame retardants, carbon black, and the like.

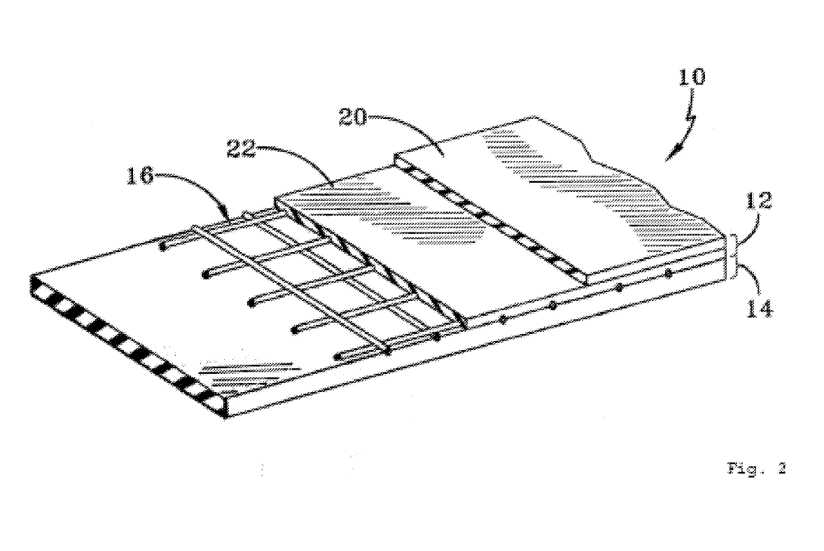

Inner layers 22 and 24 may be formed from compositions of the present invention, which include ground thermoset rubber. Bottom layer 26 may likewise be prepared from a compositions of the present invention (i.e., include ground thermoset rubber) or it may include any thermoplastic material capable of being coextruded with lower-inner layer 24. In certain embodiments, sub layer 14 (i.e., the layer below scrim 16) includes a single extruded composition such as the composition of the present invention, which includes ground thermoset rubber. Accordingly, in these embodiments, distinct co-extruded layers 24 and 26 do not exist as shown in FIG. 2, which shows layer 14 (including ground thermoset rubber), upper-inner layer 22 (including ground thermoset rubber), and top layer 20 (which is devoid or substantially devoid of ground thermoset rubber).

As those skilled in the art appreciate, upper or top layer 20 can be white or substantially white through the inclusion of white fillers. These white fillers may include clay, talc, mica, and/or titanium dioxide. For example, top layer 20 may include titanium dioxide in an amount of at least 3 percent by weight, in other embodiments at least 5 percent by weight, or in other embodiments at least 7 percent by weight, based on the total weight of the top layer. In these or other embodiments, top layer 20 may include less than 20 percent by weight, in other embodiments less than 15 percent by weight, and in other embodiments less than 12 percent by weight titanium dioxide, based on the total weight of the top layer.

In one or more embodiments, the white or substantially white layer exhibits a reflectivity of at least 75 percent, in other embodiments at least 80 percent, and in other embodiments at least 85 percent, where the reflectivity is a measure of the reflectants of visible light. In other embodiments, the reflectivity is a measure of visible and infrared electromagnetic radiation. In other embodiments, the reflectivity is a measure of the reflectants of visible light, infrared radiation, and UV radiation.

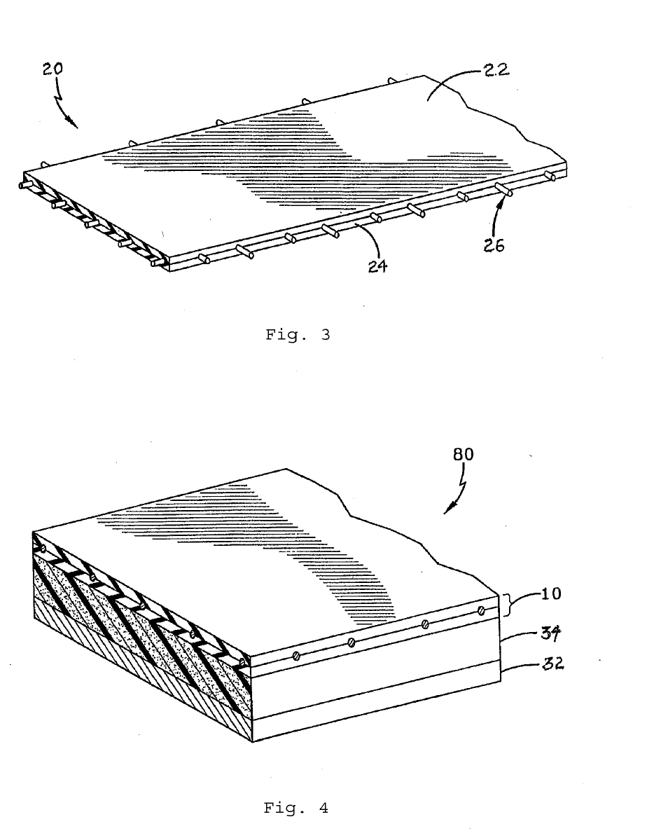

In one or more embodiments, the membranes of the present invention include two layers laminated to one another with an optional scrim disposed between the layers. In one or more embodiments, both layers include ground thermoset rubber dispersed within a thermoplastic polyolefin according to the present invention. An example of this membrane is shown in FIG. 3, which shows membrane 20 having two layers. The first or upper layer 22, which includes ground thermoset rubber, the second or lower layer 24, which includes ground thermoset rubber, and optional scrim 26 disposed therebetween.

In one or more embodiments, and again with reference to FIG. 3, the membranes of one or more embodiments may include two layers laminated to one another (22, 24) with optional scrim 26 disposed therebetween. In these embodiments, layer 22, which may be referred to as upper layer 22, is white or substantially white in color and devoid or essentially devoid of ground thermoset rubber. This layer can be exposed to the environment when installed on a roof. Second layer 24, which may also be referred to as lower layer 24, is prepared from compositions of the present invention (i.e., includes ground thermoset rubber, thermoplastic polyolefin, and compatibilizer). In one or more embodiments, the thickness of layers 22 and 24 may be the same or substantially similar. In other embodiments, particularly where the reinforcing scrim is absent, the thickness of upper layer 22 may be thinner than lower layer 24, which will provide economic benefit while allowing the constituents within upper layer 22 (e.g., white filler and/or antioxidants) to provide weather and environmental resistance to the membrane.

In one or more embodiments, the membranes of the present invention are characterized by a 100% modulus, according to ASTM D 412, of less than 700 psi, in other embodiments less than 600 psi, and in other embodiments less than 550 psi. In these or other embodiments, the membranes of this invention are characterized by a 100% tension set, according to ASTM D 142, of less than 10%, in other embodiments less than 5%, in other embodiments less than 4%, in other embodiments less than 3%, and in other embodiments less than 2%.

### Use

The membranes of one or more embodiments of the present invention are useful in a number of applications. In one embodiment, the membranes may be useful for roofing membranes that are useful for covering flat or low-sloped roofs. In other embodiments, the membranes may be useful as geomembranes. Geomembranes include those membranes employed as pond liners, water dams, animal waste treatment liners, and pond covers.

As described above, the membranes of one or more embodiments of the present invention may be employed as roofing membranes. In one or more embodiments, these membranes include thermoplastic roofing membranes including those that may meet the specifications of ASTM D-6878-03. These membranes maybe employed to cover flat or low/sloped roofs. These roofs are generally known in the art as disclosed in U.S. Ser. Nos. 60/586,424 and 11/343,466, and International Application No. PCT/US2005/024232, which are incorporated herein by reference. As shown in FIG. 4, a flat or low-sloped roof assembly 30 may include a roof deck 32, and optional insulation layer 34, and membrane 10 according to the present invention.

Practice of this invention is not limited by the selection of any particular roof deck. Accordingly, the roofing systems herein can include a variety of roof decks. Exemplary roof decks include concrete pads, steel decks, wood beams, and foamed concrete decks.

Practice of this invention is likewise not limited by the selection of any particular insulation board. Moreover, the insulation boards are optional. Several insulation materials can be employed including polyurethane or polyisocyanurate cellular materials. These boards are known as described in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which is incorporated herein by reference.

In other embodiments, these membranes may be employed to cover flat or low-slope roofs following a re-roofing event. In one or more embodiments, the membranes may be employed for re-roofing as described in U.S. Publication No. 2006/0179749, which are incorporated herein by reference.

In order to demonstrate the practice of the present invention, the following examples have been prepared and tested. The examples should not, however, be viewed as limiting the scope of the invention. The claims will serve to define the invention.

### EXAMPLES

The following samples were generally prepared according to the following procedure. A thermoplastic polyolefin, such as propylene/ethylene reactor copolymer, and linear low density polyethylene (LLDPE) were melt blended in an internal mixer operating at about 170° C. and 50 rpm for 10 minutes. The compatibilizer was added to the melt and once good dispersion was achieved, the ground thermoset rubber was added slowly to the mixer. The mix torque was monitored during the addition of the rubber and the oil was introduced in order to maintain adequate torque. The lubricant was likewise added at this stage of the mixing process. Once the rubber was added to the melt and dispersed therein, the carbon black concentrate, antioxidant, and UV stabilizers were added. Mixing was continued to achieve a good dispersion of all of the ingredients. Test specimens of each of the samples were prepared by compression molding plaques that were 6″×6″×4 mill (1.1 micrometer).

The thermoplastic polyolefins that were used included a random polypropylene, recycled TPO membrane, and reactor TPO. The random polypropylene was obtained under the tradename P5-012 (Flinthills), which was characterized as a random polypropylene copolymer with ethylene. The reactor TPO was obtained under the tradename Hifax CA10A (LyondellBassel), which was characterized as a reactor blend of polypropylene and ethylene-propylene rubber. The recycled TPO membrane was reclaimed from the thermoplastic roofing membrane that was believed to generally include a reactor TPO, various stabilizers that provide weather resistance, and nylon or polyester deriving from a nylon and/or polyester scrim. The recycled TPO was prepared by shredding the reclaimed membrane, processing the shredded pieces within a twin-screw extruder, and intruding a copolymer of ethylene, butyl methacrylate, and maleic anhydride (Lotader 3410; Akrema) at a 1.5 wt % loading. The procedure for preparing the recycled TPO membrane is disclosed in U.S. Publ. No. 20100222514, which is incorporated herein by reference.

The LLDPE was obtained under the tradename GA502023 and was characterized by a melt index of about 2; the extender oil was obtained under the tradename Sunpar 160 (R.E. Carroll); the carbon black concentrate included a masterbatch of 60% carbon black dispersed in polypropylene; lubricant #1 was obtained under the tradename TR-016 (Struktol); lubricant #2 was obtained under the tradename Stan-lube 6056 (Harwick Standard); the antioxidant package was obtained under the tradename BNX 1225 (Mayzo); UV stabilizer #1 was obtained under the tradename Ciba XT-850 (Ciba); and the UV stabilizer #2 was obtained under the tradename Tinuvin 770 (Ciba). The EVA compatibilizer was obtained under the tradename Evatane 28-05 (Arkema) and characterized by including units deriving from vinyl acetate. The functionalized block copolymer compatibilizer was obtained under the tradename FG1901X (Kraton) and was characterized as an S-EB-S (i.e. hydrogenated SBS block copolymer) having a styrene content of about 30%, a bound maleic anhydride content of about 1.4-2.0 wt %, and a melt flow rate of about 14-28 (230 C and 5000 g load).

Each of the test specimens were subject to various physical and mechanical tests. The ingredients used to prepare each sample and the results of the various tests are set forth in Table I.

TABLE I

Sample

| | | | |
|---|---|---|---|
| 1 | 2 | 3 | 4 |

Ingredients

| | | | | |
|---|---|---|---|---|
| Ground Butyl Rubber | — | — | — | 60 |
| (60 mesh) | | | | |
| Ground EPDM (40 mesh) | 60 | 60 | — | — |
| Ground EPDM (80 mesh) | — | — | 60 | — |
| Random Polypropylene | — | — | 11.7 | — |
| LLDPE | 18 | 18 | 10 | 7 |
| Recycled TPO membrane | 12 | 6 | — | 9 |
| Functionalized Block | — | — | 10 | — |
| Copolymer | | | | |
| EVA | — | 6 | — | 16 |
| Extender Oil | 7 | 7 | — | 5 |
| Black Concentrate | 2.5 | 2.5 | — | 2.5 |
| Lubricant #1 | 0.1 | 0.1 | 0.1 | 0.1 |
| Lubricant #2 | — | — | 8 | — |
| Antioxidant | 0.2 | 0.2 | 0.1 | — |
| UV stabilizer #1 | 0.2 | 0.2 | — | 0.2 |
| UV stabilizer #2 | — | — | 0.1 | 0.2 |

Test Data

| | | | | |
|---|---|---|---|---|
| Thickness (mil) | 35 | 45 | — | 47 |
| Tensile Strength (psi) | 594 | 710 | 920 | 1057 |
| Tensile Elongation (%) | 144 | 428 | 251 | 404 |
| 100% modulus (psi) | 563 | 610 | 729 | 528 |
| Die-C Tear Strength | 164 | 206 | 205 | 210 |
| Puncture Resistance (lbf) | 25 | 33.7 | — | 36 |
| Melt Flow (g/10 min) | 4.8 | 0.6 | — | — |

All testing was conducted in conformance or substantial conformance with ASTM standards. Various modifications and alterations that do not depart from the scope and spirit of this invention will become apparent to those skilled in the art. This invention is not to be duly limited to the illustrative embodiments set forth herein.

What is claimed is:

1. A multi-layered membrane comprising:
i. a first layer that is substantially white in color; and
ii. a second layer including ground thermoset rubber.

2. The composition of claim 1, where the first layer includes a non-black filler selected from the group consisting of clay, talc, titanium dioxide, and silica.

3. The composition of claim 1, where the first layer further includes an antioxidant.

4. The composition of claim 1, where the first layer includes a thermoplastic olefinic polymer.

5. The composition of claim 1, where the second layer includes a thermoplastic olefinic polymer, and wherein said ground thermoset rubber is dispersed in said thermoplastic olefinic polymer.

6. The composition of claim 1, where the ground thermoset rubber has a number average particles size of from about 100 to about 1,000 μm.

7. The composition of claim 1, where said second layer includes a polymeric compatibilizer.

8. The composition of claim 1, where the polymeric compatibilizer includes an acidic functionality and an amorphous component.

9. The composition of claim 1, where the polymeric compatibilizer includes polyethylene vinylacetate.

10. The composition of claim 1, where the polymeric compatibilizer includes a random terpolymer of ethylene, acrylic ester, and maleic anhydride.

11. The composition of claim 1, where the polymeric compatibilizer includes a functionalized block copolymer.

12. A membrane prepared from a polymeric composition comprising:
i. a thermoplastic polyolefin;
ii. ground thermoset rubber; and
iii. a polymeric compatibilizer, where the ground thermoset rubber is dispersed within the thermoplastic polyolefin.

13. A thermoplastic composition comprising:
i. a thermoplastic polyolefin;
ii. ground thermoset rubber; and
iii. a polymeric compatibilizer, where the ground thermoset rubber is dispersed within the thermoplastic polyolefin.
